(19) United States
(12) Patent Application Publication
(10) Pub. No.: US 2008/0290751 A1
(43) Pub. Date: Nov. 27, 2008

(54) Brushless permanent magnet motor with unequal-width slots and method of producing the same

(76) Inventors: Chang-Chun Hwang, Taichung City (TW); Shih-Ping Cheng, Taichung City (TW); Ping-Lun Li, Yijhu Township (TW); Wen-Yen Shen, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/153,284

(22) Filed: May 16, 2008

(30) Foreign Application Priority Data
May 25, 2007 (TW) 096118651

(51) Int. Cl. H02K 21/12

(52) U.S. Cl. 310/156.01

(57) ABSTRACT

A brushless permanent magnet motor with unequal-width slots and its manufacturing method completes a design of a regular motor with equal-width slots, employs a single-layer centralized winding, increasing the width equally on left and right sides of a first type of teeth wound with a coil until a width Wₜ₃ of a tooth tip equals to a width Wp of a magnetic pole, such that the stator slot opening shifts towards a second type of teeth with no coil, increasing a width of a first type of teeth with a coil equally on left and right sides until a coil pitch equals to a width Wp of a magnetic pole or a motor angle equals to 180°, and decreasing a width Wₜ₂ of a second type of teeth with no coil equally on both left and right sides until a slot area Sa₂ is greater than the original slot area Sa₁ of a regular motor with equal-width slots to improve the motor efficiency and reliability for a variable speed operation.

### BACKGROUND OF THE INVENTION

1. Field of the Invention

The present invention relates to a brushless permanent magnet motor design, and more particularly to a brushless permanent magnet motor that adjusts the width of a tooth tip of a stator wound with a coil to be equal to the width of a magnetic pole of a magnet of a rotor.

2. Description of the Related Art

Firstly, the terminologies used in this specification are defined below.

Slot is a groove of a motor stator core, which is also a space for containing the windings of a coil Slot is also known as “Groove”, but “Slot” is used throughout this specification to avoid ambiguity.

Tooth is a protrusion formed at a motor stator groove. Tooth is also known as “Groove tooth”. “Protruding tooth”, but “Tooth” is used throughout this specification to avoid ambiguity.

“Slot” used in this specification refers to a “tooth”, a “slot”, or a combination of both.

In recent years, brushless permanent magnet motor (also known as permanent magnet brushless motor) is used extensively in many different areas such as air-conditioners, fans, computers, printers, copying machines and other machines, and the key point of selecting a motor is nothing more than the comparison of its efficiency, operating torque, and reliability.

As to a brushless permanent magnet motor, the winding method is divided into two types, respectively a concentrated winding method and a distributed winding method. The concentrated winding method is more popular than the distributed winding method because the concentrated winding method has no overlapped winding, and thus the size of the motor can be reduced, and the length of end winding of the motor can be shortened. As a result, such method not only saves material costs, but also reduces copper loss and improves motor operating efficiency. The present invention aims at improving a motor stator made by the centralized winding method.

Referring to FIGS. 1 and 2 for a conventional concentrated winding stator structure 10, the stator core 11 is formed by stacking a plurality of silicon steel plates, and a tooth tip 121 is formed separately on both distal ends of the tooth 12 between two slots 13 for positioning a coil 14 as shown in an enlarged schematic view of FIG. 3, and a slot opening 131 must be reserved between the two tooth tips 121 for passing through the coil 14, and the centralized winding winds the coil 14 directly at the pitch of the teeth 12 without winding across the slot 13, and thus we can shorten the length of end winding at a distal end of the coil to reduce the resistance of the coil and the copper loss to improve the efficiency of the motor.

Another advantage of the centralized winding is its easy winding, since the distributed winding must be wound: across a plurality of slots 13, and the distal portion of each coil will be overlapped, and the winding operation is very complicated, and the centralized winding can wind the coil 14 at the tooth 21 directly by a nozzle of a winding machine. This is the reason why most motors used in multimedia devices such as hard disk drives, optical disk drives and DVD players adopt the centralized winding.

Although the centralized winding has many advantages, its stator structure 10 still has existing shortcomings including an issue of the slot fill factor of the coil. Since the nozzle of the winding machine is used for winding the coil 14, a winding track of the nozzle cannot receive the coil 14, and thus lowering the slot fill factor of the coil in the slot 13. Although this problem can be solved by dividing the ferrite core, the process of dividing the ferrite core requires an additional manufacture process, and also creates a precision issue of a rotation air gap. Therefore, the centralized winding is not applicable for small to mid-sized motors.

Further, there is a flux weakening problem. Compared with the distributed winding having a flux weakening control design for each pole, the centralized winding causes a flux strengthening effect at a pole, but a flux weakening effect on another opposite pole. Therefore, the centralized winding is not applicable for the flux weakening control. Even if a 2:3 series having 8 poles and 12 slots is adopted, a certain level of flux weakening control can be achieved, but the reluctance torque, similar to the flux weakening control, cannot be produced easily.

In addition, the slots of the conventional stator structure 10 come with an equal-width design, so that the width of the tooth tip 121 differs from the width of a magnetic pole of a magnet 21 of the rotor 20 and affects the properties including the flux linkage, the winding factor and the torque of the coil 14. As a result, the overall reliability and efficiency of the motor cannot be enhanced, and the application of the motor is limited.

### SUMMARY OF THE INVENTION

In view of the shortcoming of the prior art, the inventor of the present invention conducted extensive researches and experiments, and finally developed a brushless permanent magnet motor with unequal-width slots to overcome the shortcoming of the prior art.

It is a primary object of the invention to provide an unequal-width slot design with a stator adopting a centralized winding to reduce an end winding length of the motor, a copper wire consumption and a copper loss and to improve the motor efficiency.

Another object of the present invention is to provide an unequal-width slot design that adjusts the width of a tooth tip of a stator wound with a coil to be equal to the width of a magnetic pole of a magnet of a rotor to improve the flux linkage of the coil, and also adjusts the tooth width, such that the coil pitch equals to a motor angle of 180°. Therefore, the pitch factor Kp of the coil is equal to sin 180°/2=1, and the coil winding factor, the coil efficiency, and the motor EMF and torque are improved accordingly. Since the coil pitch is equal to a motor angle of 180, therefore the winding factor of each step wave of the EMF is equal to 1, and the EMF waveform of such motor is closer to a step wave that the EMF waveform of a traditional motor structure. Compared with a regular motor structure with a traditional distribution of slots, the motor structure of the invention is more applicable for a brushless permanent magnetic DC motor driven by a square wave current.

A further object of the present invention is to provide an unequal-width slot design for increasing the width of a flat portion at the top of an EMF waveform, such that the range of adjusting the speed of a motor by using a flux weakening control, and the brushless permanent magnet motor with an unequal-width slot design is more applicable for variable speed operations.

In order to achieve the above-mentioned objects, the invention includes the steps of:

(a) selecting a motor stator having a number of slots NS equal to a multiple of 6, and selecting an even number approximately equal to or slightly less than the number of slots NS of the motor stator as the number of poles Np of a rotor magnet;

(b) designing the motor with the selected number of poles Np, number of slots NS and regular equal-width slot structure, and adopting a single-layer centralized winding;

(c) analyzing and computing the EMF, current, inductance, efficiency and slot fill factor of the motor, and adjusting the motor structure, coil diameter and number of coil turns repeatedly, until the conditions of the design are satisfied;

(d) examining and verifying a magnetic flux density of a stator tooth and a back iron to prevent the occurrence of a magnetic flux saturation, and completing a structural design of a regular equal-width slot motor, such that each slot area is equal to Sa₁;

(e) maintaining the width Ws of a slot opening unchanged, and equally increasing the width on both left and right sides of a tooth tip of a first type of teeth wound with a coil until the width Wₜ₃ of the tooth tip is equal to the width Wp of a magnetic pole, such that the stator slot opening shifts towards a second type of teeth wound with the coil;

(f) adjusting the width Wₜ₂ of a first type of teeth wound with a coil, and equally increasing the width of both sides of the first type of teeth until the coil pitch is equal to the width Wp of a magnetic pole, and a motor angle is equal to 180°;

(g) adjusting the width Wₜ₂ of a second type of teeth without a wound coil, and equally decreasing the width on both sides of the second type of teeth until a slot area Sa₂ is greater than the original slot area Sa₁ of the regular equal-width slot motor; and

(h) examining and verifying the magnetic flux density of the stator tooth and the back iron to prevent the occurrence of a magnetic flux saturation.

### BRIEF DESCRIPTION OF THE DRAWINGS

FIG. 1 is an exploded view of a conventional stator core;

FIG. 2 is a schematic view of a conventional stator core;

FIG. 3 is an enlarged sectional view of a portion of structure depicted in FIG. 2;

FIG. 4 is a schematic view of a preferred embodiment of the invention;

FIG. 5 is an enlarged sectional view of a portion of structure depicted in FIG. 4; and

FIG. 6 is an enlarged sectional view of a portion of structure depicted in FIG. 4, showing the magnetic poles and the width of a tooth tip of the invention.

### DETAILED DESCRIPTION OF THE PREFERRED EMBODIMENTS

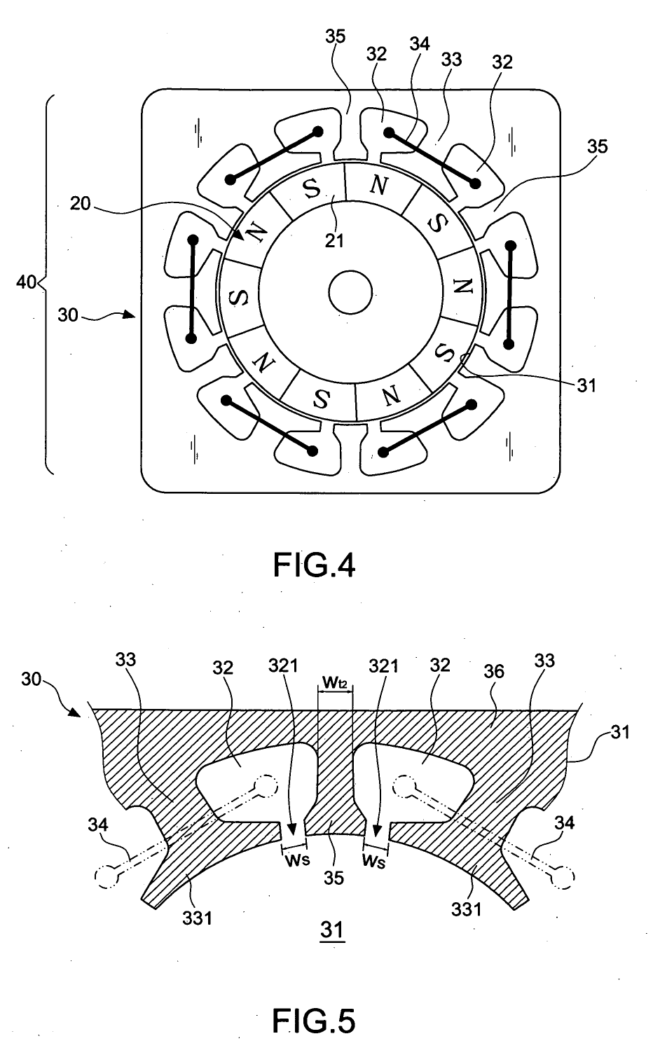

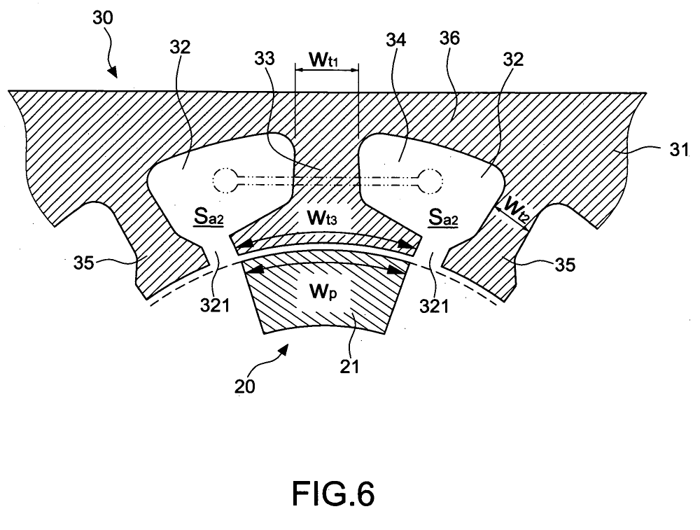

Referring to FIG. 4 for a schematic view of a preferred embodiment of the invention and FIGS. 5 and 6 for enlarged sectional views of a portion of structure of the preferred embodiment respectively, a brushless permanent magnet motor 40 with unequal-width slots comprises the following elements:

A stator 30 includes a plurality of teeth 33, 35 and slots 32 disposed along the periphery of a center penetrating hole 31, wherein the number of slots NS is a multiple of 6 such as 6 slots, 12 slots, 18 slots and so on, and the number of slots 32 and teeth 33, 35 of the stator 30 is equal to 12 each, including but not limited to a 12-slot design, and the stator 30 adopts a single-layer centralized winding to wind a coil 34 at intervals of a first type of teeth 33.

A rotor 20 is installed in the stator 30, and the number of poles Np of a magnet 21 at the periphery of the rotor 20 is selected to be approximately equal to or slightly less than the stator slot 32 an even number of slots NS that serves as the number of poles Np of the magnet 21 of the rotor 20. This embodiment preferably uses 10 poles, but the invention is not limited to such arrangement only.

The present invention is characterized in that the stator 30 includes a plurality of teeth namely a first type of teeth 33 and a second type of teeth 35 disposed alternately with each other, and the first type of teeth 33 is wound with a coil 34, and the width Wₜ₃ of a tooth tip 331 is equal to the width Wp of a magnetic pole, such that each slot opening 321 of the stator 30 shifts towards the second type of teeth 35, and the width Wₜ₁ of the first type of teeth 33 at each coil pitch is equal to the Wp of a magnetic pole, which has a motor angle of 180°.

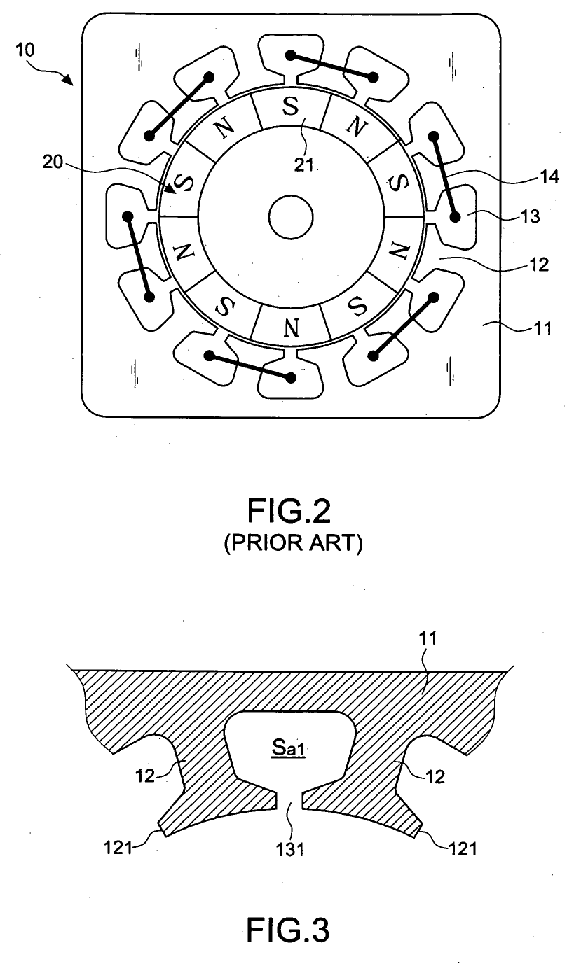

The width Wₜ₂ of the second type of teeth 35 is decreased equally on both left and right sides for expanding a slot area Sa₂, such that the slot area Sa₂ is greater than or equal to the original slot area Sa₁ of the regular motor with equal-width slots as shown in FIG. 3.

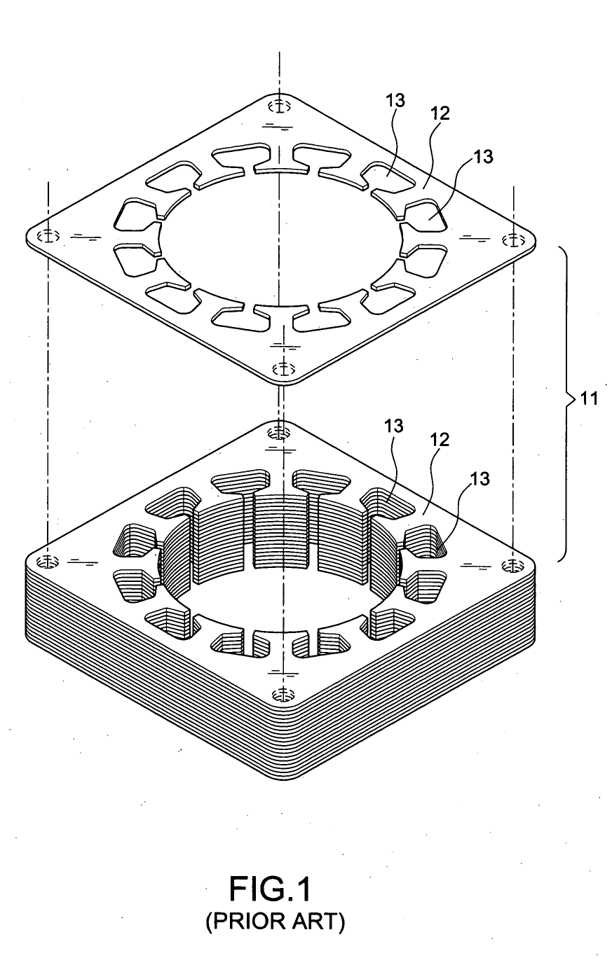

In FIG. 4, the slot area Sa₂ of each slot 32 of the stator is equal, and any two adjacent slots 32 are in a symmetric shape installed in opposite directions, and thus the unequal-width slot design of the invention is different from the design of a regular motor with equal-width slots as shown in FIGS. 1 to 3.

The unequal-width slot structure of the invention can achieve the aforementioned effects by providing a method of manufacturing a brushless permanent magnet motor 40 with unequal-width slots, and the method comprises the steps of:

(a) selecting a number of slots NS equal to a multiple of 6 for the slots 32 of the motor stator 30, such as 6 slots, 12 slots, 18 slots, and so on, and also selecting an even number of rotor magnets 21 approximately equal to or slightly less than the number of slots NS of a motor stator as the number of poles Np;

(b) using the selected number of poles Np, number of slots NS, and regular equal-width slot structure to design the, and adopting a single-layer centralized winding;

(c) analyzing and computing the EMF, current, inductance, efficiency and slot fill factor of the motor, and adjusting the motor structure, coil diameter and number of coil turns repeatedly until the conditions of the design are satisfied;

(d) examining and verifying the magnetic flux density of a stator tooth and a back iron to prevent the occurrence of a magnetic flux saturation, so as to complete the structural design of a regular motor with equal-width slots, and now each slot area being equal to Sa₁;

(e) maintaining the width Ws of a slot opening unchanged, and increasing the width of a tooth tip 331 of the first type of teeth 33 of the coil 34 equally on both left and right sides until the width Wₜ₃ of the tooth tip 331 is equal to the width Wp of a magnetic pole of the magnet 21, such that the slot opening 321 of the stator shifts towards the second type of teeth 35 without being wound by the coil 34;

(f) adjusting the width Wₜ₁ of the first type of teeth 33 wound with a coil 34 such that the width of the first type of teeth 33 is increased equally on both left and right sides until the coil pitch is equal to the width Wp of a magnetic pole, or the motor angle is equal to 180°;

(g) adjusting the width W t2 of the second type of teeth 35 without being wound with a coil 34, such that the width of the second type of teeth 35 is decreased equally on both left and right sides until the slot area Sa₂ is greater than the original slot area Sa₁ of a regular motor equal-width slots; and

(h) examining and verifying the magnetic flux density of a stator tooth and a back iron to prevent the occurrence of a magnetic flux saturation.

With the aforementioned technical measures and method, the present invention adjusts the width of a tooth tip of a stator wound with a coil to be equal to the width of a magnetic pole of a magnet of a rotor, in order to improve the flux linkage of the coil; and also adjusts the tooth width such that the coil pitch is equal to a motor angle of 180°, and thus the coil pitch factor Kp is equal to sin 180°/2=1. As a result, the coil winding factor, the coil efficiency, and the motor EMF and torque are improved accordingly. Since the coil pitch is equal to a motor angle of 180°, therefore the winding factor of each step wave of the EMF is equal to 1, and the EMF waveform of such motor is closer to a step wave than the EMF waveform of a traditional motor. Compared with a regular motor structure 1 having a traditional distribution of slots, the brushless permanent magnetic DC motor structure driven by a square wave current is more applicable.

Since the motor adopts an unequal-width slot design to increase the width of a flat portion at the top of the EMF waveform of the motor, and the range of adjusting the speed of the motor by using a flux weakening control, therefore the brushless permanent magnet motor with an unequal-width slot design is more applicable for variable speed operations.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A method of producing a brushless permanent magnet motor with unequal-width slots, comprising the steps of:
(a) selecting a motor stator having a number of slots NS equal to a multiple of 6, and selecting an even number approximately equal to or slightly less than the number of slots NS of the motor stator as the number of poles Np of a rotor magnet;
(b) designing the motor with the selected number of poles Np, number of slots NS and regular equal-width slot structure, and adopting a single-layer centralized winding;
(c) analyzing and computing the EMF, current, inductance, efficiency and slot fill factor of the motor, and adjusting the motor structure, coil diameter and number of coil turns repeatedly, until the conditions of the design are satisfied;
(d) examining and verifying a magnetic flux density of a stator tooth and a back iron to prevent the occurrence of a magnetic flux saturation, and completing a structural design of a regular equal-width slot motor, such that each slot area is equal to Sa₁;
(e) maintaining the width Ws of a slot opening unchanged, and equally increasing the width on both left and right sides of a tooth tip of a first type of teeth wound with a coil until the width Wₜ₃ of the tooth tip is equal to the width Wp of a magnetic pole, such that the stator slot opening shifts towards a second type of teeth wound with the coil;
(f) adjusting the width Wₜ₁ of a first type of teeth wound with a coil, and equally increasing the width of both sides of the first type of teeth until the coil pitch is equal to the width Wp of a magnetic pole, and a motor angle is equal to 180°;
(g) adjusting the width Wₜ₂ of a second type of teeth without a wound coil, and equally decreasing the width on both sides of the second type of teeth until a slot area Sa₂ is greater than the original slot area Sa₁ of the regular equal-width slot motor; and
(h) examining and verifying the magnetic flux density of the stator tooth and the back iron to prevent the occurrence of a magnetic flux saturation.

2. A brushless permanent magnet motor with unequal-width slots, particularly a structure manufactured according to the method of claim 1, comprising:
a stator, including a plurality of teeth and slots disposed along the periphery of a center penetrating hole, and the number of slots NS being equal to a multiple of 6 and the stator adopting a single-layer centralized winding;
a rotor, installed in the stator, and whose number of magnet poles disposed on the periphery of the rotor being an even number approximately equal to or slightly less than the number N_{S} of stator slots and serving as the number of poles Np;
wherein the stator includes a first type of teeth and a second type of teeth installed with a pitch in between, and the first type of teeth is wound with a coil, and the width Wₜ₃ of the tooth tip is equal to the width Wp of a magnetic pole, such that each slot opening of the stator shifts towards the second type of teeth, and the width Wₜ₁ of the first type of teeth for the coil pitch is equal to the width Wp of a magnetic pole width Wp, and the motor angle is equal to 180°; and
wherein the width Wₜ₂ of the second type of teeth without a wound coil is decreased equally on both left and right sides for expanding the slot area Sa₂.

3. The brushless permanent magnet motor with unequal-width slots as recited in claim 1 wherein the slot area Sa₂ of each slot of the stator is equal, and any two adjacent slots are in a symmetric shape installed in opposite directions.
